(19) United States
(12) Patent Application Publication
(10) Pub. No.: US 2023/0364594 A1
(43) Pub. Date: Nov. 16, 2023

(54) Catalytic Production of Diesel-like Oils from Plastic Waste

(71) Applicant: Baron Boghosian, West Hills, CA (US)

(72) Inventor: Baron Boghosian, West Hills, CA (US)

(21) Appl. No.: 18/246,509

(22) PCT Filed: Sep. 24, 2021
(86) PCT No.: PCT/US2021/051995

§ 371 Date: Mar. 23, 2023

Related U.S. Application Data
(60) Provisional application No. 63/083,295, filed on Sep. 25, 2020.

(51) Int. Cl. B01J 29/48; B01J 23/888; B01J 37/00

(52) U.S. Cl. CPC B01J 29/48; B01J 23/888; B01J 37/0018; B01J 2229/186

(57) ABSTRACT

A dewaxing catalyst was prepared through the dissolution of nickel oxide and tungsten powders in an aqueous medium, followed by the impregnation of a ZSM-5 substrate and calcination at 500° C. The synthesized catalyst was used in conjunction with a pyrolytic reactor running at a set point of 360° C. to break down a mixture of plastic grocery bags. The catalyst was found to be selective to the C9 - C22 isomers typical of diesel No. 2. Gas chromatographic analysis indicated the fraction of C24 and heavier components in the pyrolysis product was only 1.0%.

### CROSS-REFERENCE TO RELATED APPLICATIONS

This application claims priority from U.S. Provisional Pat. Application No. 63/083,295 filed on Sep. 25, 2020. The entire disclosure of the prior application is considered to be part of the disclosure of the accompanying application and is hereby incorporated by reference.

### BACKGROUND OF THE INVENTION

### 1. Field of the Invention

Embodiments of the present disclosure generally relate to the preparation of a dewaxing catalyst used in conjunction with a pyrolytic reactor to break down a plastic feedstock into diesel fuel and more specifically to the elements that comprise the catalyst. The invention discloses methods of manufacture and uses of the catalyst in the thermocatalytic cracking of the plastic feedstock into diesel.

### 2. Description of the Related Art

It is well established that more than 350 million tons of plastic waste are produced worldwide annually, which brings about severe environmental issues, largely due to their life cycle and difficulty of elimination. The majority of plastic wastes end up in one of two places, the landfill, or the ocean. Significant amounts of plastics break down into microplastics which fish and other marine life ingest, ultimately devastating the entire ecosystem. According to the National Oceanic and Atmospheric Administration (NOAA) publication “A Guide to Plastic in the Ocean”, approximately 8 million metric tons of plastics entered the ocean in 2010. The Environmental Protection Agency (EPA) further reports in their publication “Plastics: Material-Specific Data” that landfills received an estimated 26.8 million tons of plastic in 2017, accounting for 19.2% of all municipal solid waste dumped. Recycling has become an attractive way to clean up plastics in the environment. Common plastic recycling options and end-of-life treatments include incineration with energy recovery, pyrolysis, mechanical recycling, solvolysis, and dissolution/precipitation. Contrary to paper recycling where preserving fiber morphology (e.g., length and diameter) is very important, plastic wastes are often upgraded into other products or converted to heat. For example, a significant amount of plastic is burnt as part of municipal disposal programs; an estimated 5.6 million tons of plastic was combusted in 2017. Incineration as a means of disposal is ecologically unsustainable as it releases toxic compounds including dioxins, furans, mercury, and polychlorinated biphenyls into the atmosphere. In an attempt to recover valuable energy that is intrinsic to plastic waste, traditional pyrolytic or thermolytic methods have been studied in recent times. Pyrolysis is the thermochemical decomposition of carbon-based matter in the absence of oxygen; the primary goal is to transform organic waste into sustainable fuel or other valuable chemicals. Pyrolysis is thought of as an alternative recycling method that has gained traction due to its potential to recover most energy from plastic wastes, in the forms of liquid oils, gases, and char. Because of this flexibility, it has been chosen by many researchers as an area of development. Co-pyrolysis of biomass and waste plastics has also gained interest as an economical, and effective biofuel technique.

The physical and chemical characteristics of the product obtained from plastic pyrolysis are a function of the type of plastic used, the operating conditions of the pyrolysis reactor, and the type of catalyst used. Typical kinds of plastic used in pyrolysis are high-density polyethylene (HDPE), low-density polyethylene (LDPE), polypropylene (PP), and polystyrene (PS). Note that halogenated plastics such as polytetrafluoroethylene (PTFE) or polyvinyl chloride (PVC) cannot be used for this process. The issue surrounding halogenated plastics is that they can react with other components in the fuel mixture to form poisonous compounds. With traditional thermal pyrolysis (i.e. without a catalyst), the pyrolysis process may yield wax and char, depending on the nature of the plastic feedstock. An earlier study on pyrolysis of a simulated plastic mixture found in municipal solid waste by E. A. Williams and P. T. Willans titled “Analysis of Products Derived from the Fast Pyrolysis of Plastic Waste”, recorded a 17.28% yield of wax and a 2.82% yield of char when tested at 500° C. At higher temperatures, the amount of wax is reduced, and the oil product is more aromatic. When the temperature goes beyond 700° C., a product with properties nearly identical to gasoline was yielded. However, sustaining such a high temperature is expensive and energy-intensive. The use of a catalyst not only decreases the reaction temperature but also enhances the depolymerization efficiency and increases selectivity. Catalytic pyrolysis has been shown to be a more economically sustainable process. In this work, an inexpensive catalyst is synthesized in the lab and is used in conjunction with a lab-designed catalytic reactor that operates at atmospheric pressure. For a demonstration of the concept, mixed plastic grocery bags from a supermarket are selected as feedstock for the pyrolysis experiments.

The U.S. Pat. 8,344,195 to Srinakruang discloses a process for producing fuel by cracking a plastics-derived liquid, which is obtained from a pyrolysis process, using a dolomite catalyst. The plastics-derived liquid is produced by the pyrolysis of plastic waste, such as one or more of polyethylene, polystyrene, or polypropylene. The plastic-derived liquid is first subjected to a semi-batch catalytic cracking reaction over a very low-cost dolomite catalyst to obtain high-quality oil for fuel, which comprises mainly light and heavy naphtha. Moreover, the catalytic cracking reaction is conducted at operating temperatures lower than 320° C.

The U.S. Pat. 9,200,207 to Huang et al discloses a method of producing liquid hydrocarbon fuels for solid waste plastic by reacting the waste plastic with a metal hydride and a supported catalyst which is mixed and then gasified to produce liquid hydrocarbon.

The U.S. Pat. 10,358,603 to Pour discloses a method for producing fuels such as liquid and solid fuels from waste materials comprising rubber or plastic waste, is disclosed. The method comprises the steps of: (a) grounding said waste material into chips or flakes, (b) transferring the chips or flakes via a transmission system to a viscous fluid disorder tank, (c) introducing a catalyst to the transferred chips or flakes in the tank, (d) heating the chips or flakes with catalyst using a heating jacket or a coil in a reservoir of the tank at a predetermined temperature, (e) mixing the molten chips or flakes with catalyst using a helical butterfly stirrer inside the reservoir at a predetermined time and temperature to decompose the waste material, and (f) filtering the decomposed waste material to produce the fuel. This method is simple, quick, and economical for producing different characteristics of fuel without any environmental lesions and contamination.

As the above patents show, a catalyst is an integral part of the process of producing fuels from waste materials such as plastics. Disclosed herein is a novel and low-cost catalyst that increases the amount of fuel, particularly diesel fuel, that is produced in proportion to the amount of waste plastic being consumed.

### BRIEF SUMMARY OF THE INVENTION

A primary object of the present invention is to provide a method for producing fuels, such as diesel fuels, from a waste material comprising plastic waste. In an embodiment, the method comprises the steps of: (a) collecting, cleaning, and shredding the plastic waste material, (b) depositing the prepared plastic waste into a pyrolysis chamber, (c) purging the pyrolysis chamber of oxygen, (d) heating the pyrolysis chamber to a predetermined temperature, (e) passing the vapor created from the decomposing plastic waste material through a catalyst disclosed herein, (f) dewaxing and desulfurizing the catalyst reacted vapor, (g) cooling the vapor into a liquid; the liquid being diesel, and (h) collecting the diesel to be used in any commercial activity where diesel is used.

Another object of the present invention is to provide a method for producing fuels, such as diesel fuels, from a waste material comprising plastic waste. In an embodiment, the method comprises the steps of: (a) collecting, cleaning, and shredding the plastic waste material, (b) depositing the prepared plastic waste into a pyrolysis chamber, (c) purging the pyrolysis chamber of oxygen, (d) heating the pyrolysis chamber to a predetermined temperature, (e) injecting hydrogen gas into the catalyst reaction chamber, (f) passing the vapor created from the decomposing plastic waste material through a catalyst disclosed herein, (g) dewaxing and desulfurizing the catalyst reacted vapor, (h) cooling the vapor into a liquid; the liquid being diesel, and (i) collecting the diesel to be used in any commercial activity where diesel is used.

Yet another object of the present invention is a catalyst for the process of creating fuel, particularly diesel fuel, from waste plastic. The aforementioned catalyst is a compound of one or more metals that has been baked onto a substrate comprising ZSM-5. ZSM-5, also known as Zeolite Socony Mobil-5, is an aluminosilicate zeolite belonging to the pentasil family of zeolites. Its chemical formula is NaₙAlₙSi₉₆₋ₙO₁₉₂ 16H₂O where 0 < n < 27.

In another embodiment of the catalyst, Nickel and Tungsten is baked onto the ZSM-5 substrate.

In yet another embodiment of the catalyst, Nickel and Tungsten is baked onto the ZSM-5 substrate in such a manner that the ratio of the total weight of the catalyst, including metals, is in the ratio of 66.6% ZSM-5, 20% Nickel oxide: 13.33% Tungsten Oxide all by weight.

Further areas of applicability of the present invention will become apparent from the detailed description provided hereinafter. It should be understood, however, that the detailed description and the specific examples, while indicating specific embodiments of the invention, are given by way of illustration only, since various changes and modifications within the spirit and scope of the invention will become apparent to those skilled in the art from this detailed description. Neither this summary nor the following detailed description defines or limits the invention. The invention is defined by the claims.

### BRIEF DESCRIPTION OF DRAWINGS

The present invention will become more fully understood from the detailed description and accompanying drawings, wherein:

FIG. 1 exemplarily shows a schematic of the reactor used to convert waste plastic into fuel according to the present invention.

FIG. 2 exemplarily shows a flowchart for a method for producing fuels, such as diesel fuels, from a waste material comprising plastic waste, according to an embodiment of the present invention.

FIG. 3 exemplarily shows a flowchart of a second embodiment for a method for producing fuels, such as diesel fuels, from a waste material comprising plastic waste, according to an embodiment of the present invention.

FIG. 4 exemplarily shows a flowchart for a method for fabricating a catalyst that increases the yield of fuel produced from the pyrolysis of waste plastic according to an embodiment of the present invention.

FIG. 5 shows a reference gas chromatograph for fuel oil. A mixed standard of known linear hydrocarbons was used to relate the GC retention time to the hydrocarbon chain length.

FIG. 6 shows a gas chromatography analysis of the pyrolysis of plastic without the use of a catalyst and its associated integration results according to an embodiment of the present invention.

FIG. 7 shows a gas chromatography analysis of the pyrolysis of plastic with the use of the catalyst and its associated integration results according to an embodiment of the present invention.

FIG. 8 shows a table displaying integration results of gas chromatography data for the pyrolysis products without and with the catalyst according to an embodiment of the present invention.

FIG. 9 shows a table displaying a characterization of fuel oil derived from pyrolysis of plastic using a catalyst according to an embodiment of the present invention.

Like reference symbols in the various drawings indicate like elements.

### DETAILED DESCRIPTION OF THE INVENTION

The following description of the preferred embodiment(s) is merely exemplary in nature and is in no way intended to limit the invention, its application, or its uses.

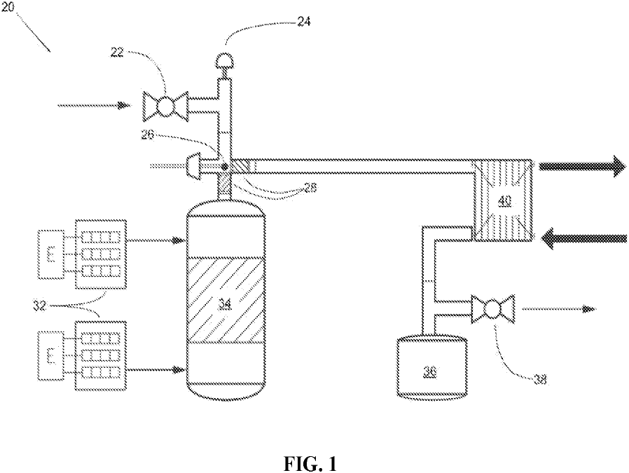

FIG. 1 shows an exemplary schematic of reactor 20 used to convert waste plastic into fuel according to the present invention. One skilled in the art would recognize that reactor 20 is exemplary and that many reactor configurations may be used to pyrolyze waste plastic. The central component of reactor 20 is pyrolysis chamber 34 where shredded waste plastic is deposited into. Waste plastic may be deposited into pyrolysis chamber 34 by opening pyrolysis chamber 34 while at room temperature or by a screw feed mechanism, not shown, while pyrolysis chamber 34 is at operating temperature. Other mechanisms to deposit waste plastic into pyrolysis chamber 34 may be used which are known to one skilled in the art. Prior to raising the temperature within pyrolysis chamber 34 to an operating temperature, pyrolysis chamber 34 must be purged of oxygen. When oxygen is not present in pyrolysis chamber 34, the waste plastic does not combust as the temperature within pyrolysis chamber 34 is raised, but rather the plastic waste thermally decomposes into desired combustible gases and undesirable char. To purge pyrolysis chamber 34 of oxygen, a mixture of 75% Argon and 25% CO2 gas is passed through pyrolysis chamber 34 via inert gas fill 22. After pyrolysis chamber 34 has been purged of oxygen, electric band heaters 32 are energized to begin heating pyrolysis chamber 34. Other means of heating pyrolysis chamber 34 may be used that are well known in the art. As the temperature within pyrolysis chamber 34 increases to the operating temperature, thermocouple 26 reports the temperature to a computer/controller, which is not shown, to appropriately energize electric band heaters 32 in order to maintain a proper operating temperature. As the waste plastic decomposes, the desired combustible gases pass through catalyst chamber 28 wherein catalyst 30 of the present invention are located. As shown in this disclosure, catalyst 30 increases the efficiency of the conversion of vapor from the decomposing plastic waste into desired combustible gases. The combustible gases are then passed through water-cooled heat exchanger 40 where the combustible gases are converted from a vapor form into a liquid. From the heat exchanger 40 the liquid is collected in collection vessel 36 where it may be further refined or used directly as a combustible fuel. In addition to the prior mentioned components, reactor 20 also includes pressure gauge/relief 24 that may be open or closed as appropriate by a computer/controller to maintain an operating pressure for the pyrolysis. Finally, any combustible gas that is not converted into a liquid after passing through heat exchanger 40 is siphoned away by volatile gas outlet 38.

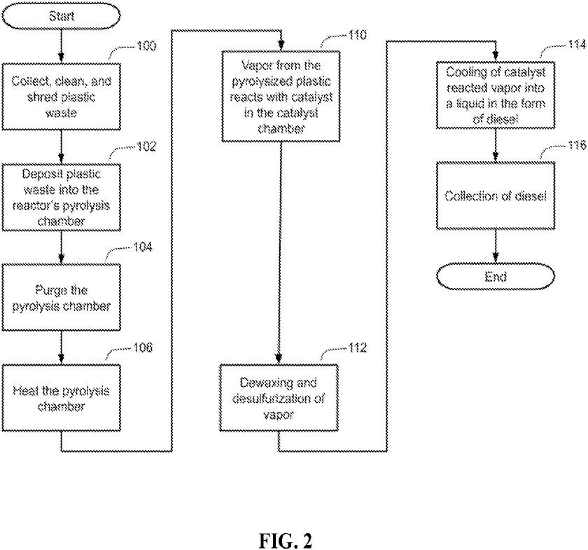

FIG. 2 exemplarily shows a flowchart for a method for producing fuels, such as diesel fuels, from a waste material comprising plastic waste, according to an embodiment of the present invention. In step 100, Preparation of waste plastic, plastic waste that is to undergo pyrolysis is prepared by first cleaning and then shredding the plastic waste. The waste plastic may be comprised of polyethylene, polypropylene, polystyrene, or polyvinyl chloride. Examples of plastic waste include domestic items such as food and beverage containers, packaging foam, electronic equipment cases, flooring, thermal insulation foams; agricultural items such as mulch films, feed bags, fertilizer bags, etc.; and more. In step 102, Introduction of waste plastic into pyrolysis chamber, the plastic waste is inserted into pyrolysis chamber 34 either manually or continuously by a feed screw mechanism. In step 104, Purging of the pyrolysis chamber, pyrolysis chamber 34 is purged of oxygen via argon carbon dioxide gas mix, to reduce any possible contaminants and impurities in the final diesel oil product as the presence of oxygen at high temperatures will cause the plastic to combust rather than simply dissociating and breaking down. In step 104, Purging of the pyrolysis chamber, the temperature of pyrolysis chamber 34 is heated up to 300 - 350° C. by means of electric band heaters 32 to break down the plastic waste. For some plastic waste, pyrolysis chamber 34 must be heated up to 400 - 450° C. in order to break down. Pressure within pyrolysis chamber 34 may be kept at atmospheric conditions, but better results are obtained at 5 - 7 PSIG. In step 110, Reaction of plastic vapor with catalyst in the catalyst chamber, the vapor produced by the pyrolysis of the plastic within pyrolysis chamber 34 travels through one or more catalyst chamber 28, each containing catalyst 30 of the present invention. The vapor then reacts with catalyst 30 to selectively crack the long hydrocarbon isomers present in the vapor to the preferred diesel olefin and aromatic carbon range for diesel fuel. In step 114, Cooling of reacted vapor into liquid diesel, the vapor, now having been cracked by catalyst 30, enters heat exchanger 40 to be cooled and undergo a phase change from a vapor to a liquid form being diesel. Finally, in step 116, Collection of diesel, the diesel is collected in collection vessel 36 to be sold as fuel or, if pyrolysis chamber 34 uses diesel fuel for heating, to heat pyrolysis chamber 34.

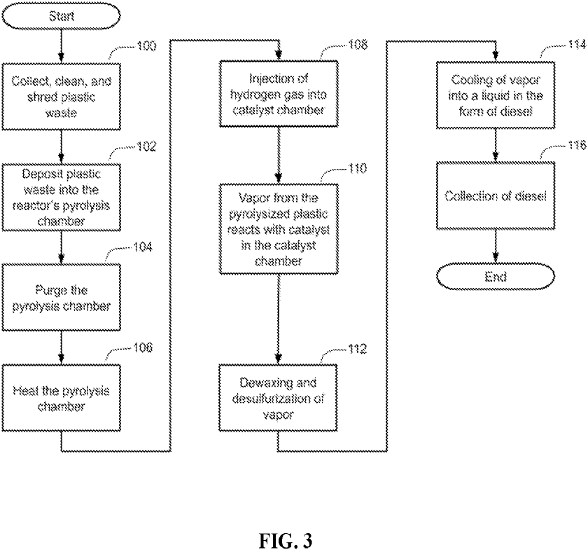

FIG. 3 exemplarily shows a flowchart of a second embodiment for a method for producing fuels, such as diesel fuels, from a waste material comprising plastic waste, according to an embodiment of the present invention. In step 100, Preparation of waste plastic, plastic waste that is to undergo pyrolysis is prepared by first cleaning and then shredding the plastic waste. The waste plastic may be comprised of polyethylene, polypropylene, polystyrene, or polyvinyl chloride. Examples of plastic waste include domestic items such as food and beverage containers, packaging foam, electronic equipment cases, flooring, thermal insulation foams; agricultural items such as mulch films, feed bags, fertilizer bags, etc.; and more. In step 102, Introduction of waste plastic into pyrolysis chamber, the plastic waste is inserted into pyrolysis chamber 34 either manually or continuously by a feed screw mechanism. In step 104, Purging of the pyrolysis chamber, pyrolysis chamber 34 is purged of oxygen via argon carbon dioxide gas mix, to reduce any possible contaminants and impurities in the final diesel oil product as the presence of oxygen at high temperatures will cause the plastic to combust rather than simply dissociating and breaking down. In step 104, Purging of the pyrolysis chamber, the temperature of pyrolysis chamber 34 is heated up to 300 - 350° C. by means of electric band heaters 32 to break down the plastic waste. For some plastic waste, pyrolysis chamber 34 must be heated up to 400 - 450° C. in order to break down. Pressure within pyrolysis chamber 34 may be kept at atmospheric conditions, but better results are obtained at 5 - 7 PSIG. In step 110, Reaction of plastic vapor with catalyst in the catalyst chamber, the vapor produced by the pyrolysis of the plastic within pyrolysis chamber 34 travels through one or more catalyst chamber 28, each containing catalyst 30 of the present invention. The vapor then reacts with catalyst 30 to selectively crack the long hydrocarbon isomers present in the vapor to the preferred diesel olefin and aromatic carbon range for diesel fuel. In addition to the presence of catalyst 30, the process of converting the vapor from the decomposition of the plastic waste when pyrolysis chamber 34 is at operating temperature to diesel fuel is further enhanced by step 112, Injection of hydrogen gas into the catalyst chamber,. The injection of hydrogen at high temperature (400 - 450° C.) and at high pressure (50 - 125 bar) in the presence of catalyst 30 enhances the conversion of the hydrodesulfurization and reduces char formation thus improving the creation of diesel fuel. In step 114, Cooling of reacted vapor into liquid diesel, the vapor, now having been cracked by catalyst 30, enters heat exchanger 40 to be cooled and undergo a phase change from a vapor to a liquid form being diesel. Finally, in step 116, Collection of diesel, the diesel is collected in collection vessel 36 to be sold as fuel or, if pyrolysis chamber 34 uses diesel fuel for heating, to heat pyrolysis chamber 34.

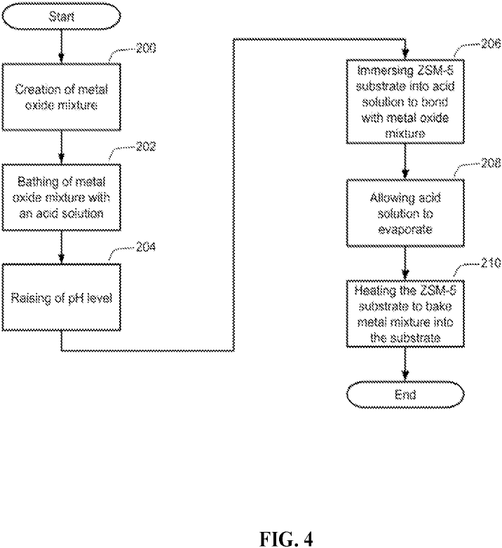

FIG. 4 exemplarily shows a flowchart for a method for fabricating a catalyst that increases the yield of fuel produced from the pyrolysis of waste plastic according to an embodiment of the present invention. Starting components for this method are ZSM-5 catalyst substrate, nickel oxide (NiO) powder, and tungsten oxide (WO₃) powder. In the preferred embodiment, the ratio of the total weight of the catalyst is in the ratio of 66.7% ZSM-5 : 20% NiO : 13.3% WO₃; all by weight. In step 200, Creation of metal oxide mixture, the NiO and WO₃ are mixed together as a homogeneous mixture and known hereafter as the metal oxide mixture. In step 202, Dissolving the mixture with acid forming a bath, the metal oxide mixture is bathed in a solution of nitric acid and hydrochloric acid in a molar ratio of 1:3, hereafter known as the acid solution, optimally to a pH level of -1.77. The ratio of acid solution to metal oxide mixture is 4 ml of acid solution to each gram of metal oxide mixture. The bathing of the metal oxide mixture with the acid solution causes the NiO and WO₃ to dissolve into their respective ions. In step 204, Raising of pH level of the bath, the combination of the metal oxide mixture with the acid solution is brought to a manageable pH in the range of 3 - 3.5 via titration of distilled water. As an alternative to distilled water alone, a mixture containing distilled water along with a base such as sodium hydroxide (NaOH) may be used to reduce the amount of time needed for evaporation in step 208, Allowing the bath to evaporate forming a product,. In step 206, Immersing ZSM-5 substrate into the bath to bond with metal oxides, the ZSM-5 substrates are added to the solution and during this time a process of deposition of the NiO and WO₃ ions onto the surface of the ZSM-5 substrate occurs. In step 208, Allowing the bath to evaporate forming a product, the acid solution is allowed to evaporate. Finally, in step 210, Heating the product to bake metal oxides onto the ZSM-5 substrate, the wet ZSM-5 catalyst, currently coated with NiO and WO₃, is transferred to an autoclave furnace to bake the NiO and WO₃ ions onto the structure of the ZSM-5 substrates permanently. Preferably, the temperature of the furnace for the baking of the NiO and WO₃ ions onto the structure of the ZSM-5 substrates is 500° C. The synthesis of catalyst 30 is then complete. The dried substrates may then be taken from the autoclave furnace and inserted into catalyst chamber 28 to be used in the pyrolysis of plastic waste to diesel fuel in order to refine the plastic fuel oil to within 90% similarity of diesel No. 2.

The pyrolysis of plastic waste into a resultant fuel that was not treated with catalyst 30, was found to have a density of 861 kg/m. This density is similar to the density of diesel No. 2, which has a density of 849 kg/m. The disparity in density is indicative of some heavier components in the resultant fuel. The resultant fuel product was analyzed by the Thermo Scientific Trace 1310 Gas Chromatography (GC) with AI1310 autosampler. The type of column used for the GC is the Phenomenex ZB-5HT (30 m × 0.25 mm × 0.1 µm film). The Split/Splitless SSL injector is set to a split ratio of 25. A flame ionization detector (FID) measures the analytes. The column flow is 1.2 mL/min using a helium gas carrier. The temperature for the GC instrument is controlled by a PID program. To prepare the sample, the fuel is diluted into methylene chloride (3% on a volume basis). The sample is put in an oven at 50° C. for 5 min, then heated up to 350° C. at a ramp rate of 15° C./min, and finally held at a steady state for 5 min.

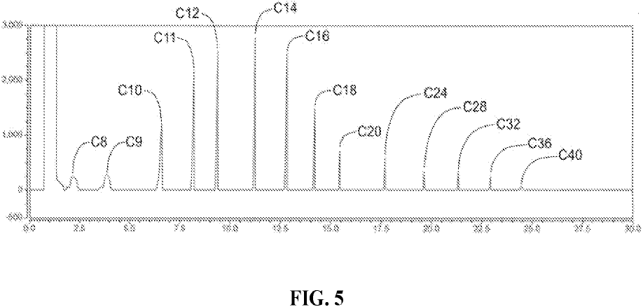

FIG. 5 shows a reference gas chromatograph for fuel oil. A mixed standard of known linear hydrocarbons was used to relate the GC retention time to the hydrocarbon chain length. This chromatograph may be used as a reference to compare with the chromatograph without and with catalyst 30.

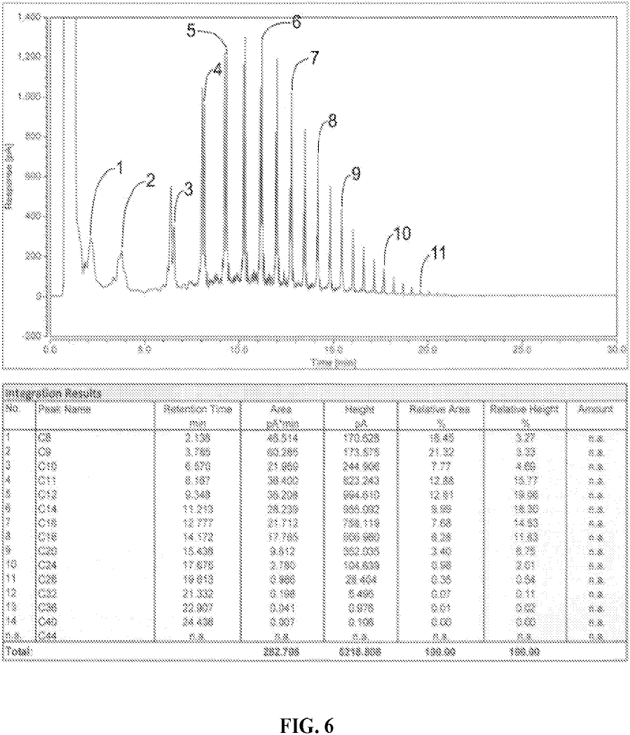

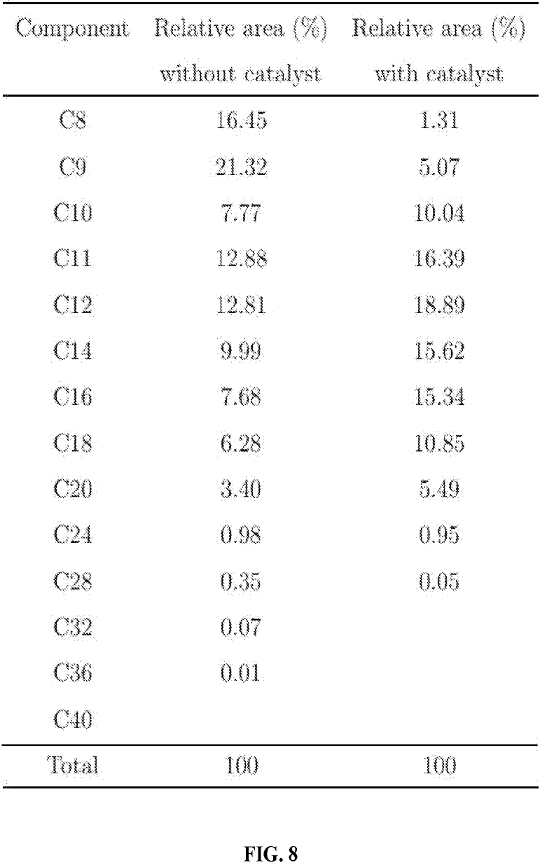

FIG. 6 shows a gas chromatography analysis of the pyrolysis of plastic without the use of catalyst 30 and its associated integration results according to an embodiment of the present invention. Though the pyrolysis fuel oil is similar to commercial diesel fuel No. 2, the former is composed of the C22 - C40 chains in higher percentages than the latter. The area under the peaks was tabulated by the GC and it was found that the fraction of C24 and heavier components in the pyrolysis product was 1.4%, as shown in the table of FIG. 8. Details of peaks identified by reference numbers in the gas chromatography chart are presented in the integration results chart below. Peaks 12, 13, and 14; shown in the integration results; were omitted from the chromatography chart as their presence is negligible.

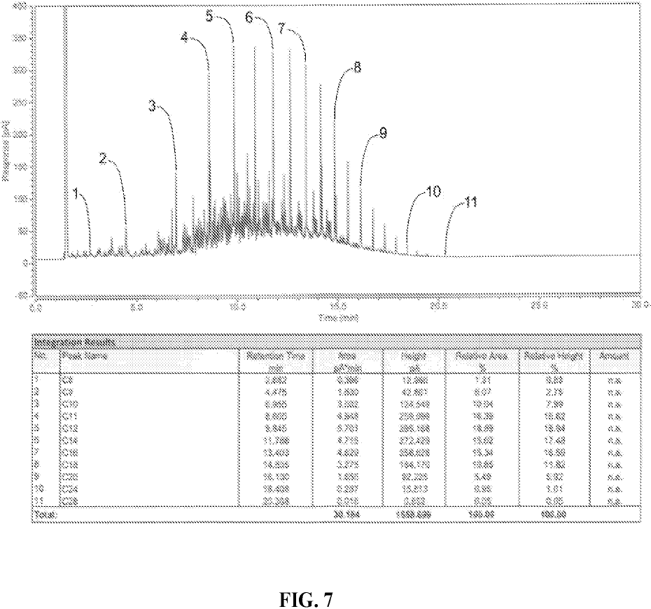

FIG. 7 shows a gas chromatography analysis of the pyrolysis of plastic with the use of catalyst 30 and its associated integration results according to an embodiment of the present invention. It can be seen that catalyst 30 has increased the cracking efficiency of the plastic waste and has modified the shape of the distribution. The distribution was found to range from C8 - C28 with the abundance peak at C12 - C16. The effect of catalyst 30 is the substantial reduction in the fraction of C24 - C40 hydrocarbons and an overall more similar distribution to the diesel. The fraction of C24 and heavier components in the pyrolysis product was calculated to be only 1.00% based on the area under the peaks in the GC as shown in the table of FIG. 8. The significance of reducing the C24 - C40 hydrocarbons from 1.41% without the catalyst to 1.0% with the aid of the catalyst can be substantiated by According to EPA, Method 1663, differentiation of diesel and crude oil by GC/FID, the difference between diesel and crude oil is that the percentage of C24 - C40 is greater than 1.2 in the latter. Therefore, reducing these heavy components is important. Moreover, it is interesting to note that C8 and C9 are significantly reduced in the diesel fuel product with catalyst 30. A probable theory to explain the significant reduction in C8 and C9 in the diesel product is as such. Oligomerization, cyclization, and aromatization reactions may occur on ZSM-5 to promote the formation of heavier products if the catalytic acidity (or catalytic activity) is high (see Mastral et al., Catalytic degradation of high-density polyethylene over nanocrystalline HZSM5 zeolite, Polym. Degrad. Stab. 91, 33303338, 2006 and a few other references). Due to the high acidity nature of the ZSM-5 substrate (Si/Al = 38) chosen in this study, these reactions may take place. Further studies are required to elucidate the mechanism. Details of peaks identified by reference numbers in the gas chromatography chart are presented in the integration results chart below.

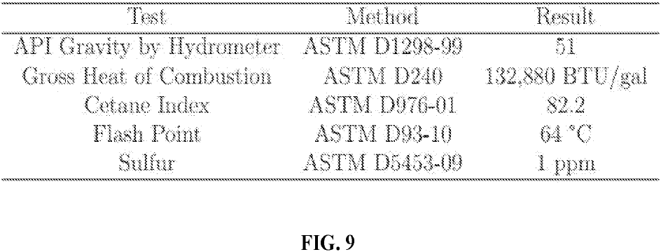

FIG. 9 shows a table displaying a characterization of fuel oil derived from pyrolysis of plastic using catalyst 30 according to an embodiment of the present invention. It confirms that the fuel produced with catalyst 30 is slightly lighter (775 kg/m3). The high heating value (HHV) is 132,880 BTU/gal, similar to 130,000 BTU/gal for Chevron No. 2 diesel. The cetane index is higher than the minimum requirement (or 40) specified in the ASTM D975 Standard Specification for commercial diesel fuel oils. The flashpoint is similar to that of Ultra-Low Sulfur Diesel (ULSD) Fuel (or 60° C.). The sulfur content in the fuel is very low, due to the fact of the feedstock used in the experiment. For other feedstock that has higher sulfur content, a hydrogen injection treatment is preferable since Ni/W/ZSM-5 is also an efficient hydrodesulfurization catalyst, which aids in sulfur removal.

The foregoing description comprises illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method.

Many modifications and other embodiments of the invention will come to mind to one skilled in the art to which this invention pertains having the benefit of the teachings presented in the foregoing descriptions. Although specific terms may be employed herein, they are used only in a generic and descriptive sense and not for purposes of limitation. Accordingly, the present invention is not limited to the specific embodiments illustrated herein. While the above is a complete description of the preferred embodiments of the invention, various alternatives, modifications, and equivalents may be used. Therefore, the above description and the examples should not be taken as limiting the scope of the invention, which is defined by the appended claims.

What is claimed is:

1. A catalyst composition useful for producing increased amounts of fuels by pyrolysis of plastic waste material, the catalyst comprising a substrate composed from ZSM-5 and at least two metal oxides.

2. The composition of claim 1 wherein the ratio of the metal oxides to ZSM-5 is 1:2 by weight.

3. The composition of claim 1 wherein the metal oxides are Nickel and Tungsten.

4. The composition of claim 3 wherein the ratio of Nickel to Tungsten is 3:2 by weight.

5. The composition of claim 3 wherein the ratio of Nickel to Tungsten to ZSM-5 is 3:2:10 by weight.

6. A method for preparing a catalyst composition useful for producing increased amounts of fuels by pyrolysis of plastic waste material, the catalyst comprising a substrate composed from ZSM-5 and at least two metal oxides which the method comprises:
mixing the at least two metal oxides as powders forming a mixture;
dissolving the mixture with acid forming a bath;
raising the pH level of the bath;
immersing ZSM-5 substrates into the bath to bond with the metal oxides;
allowing the bath to evaporate forming a product; and
heating the product to bake the metal oxides onto the ZSM-5 substrate.

7. The method of claim 6 wherein the ratio of metal oxides to ZSM-5 is 1:2 by weight.

8. The method of claim 6 wherein the metal oxides are Nickel and Tungsten.

9. The method of claim 8 wherein the ratio of Nickel to Tungsten is 3:2 by weight.

10. The method of claim 8 wherein the ratio of Nickel to Tungsten to ZSM-5 is 3:2:10 by weight.

11. The method of claim 6 wherein the acid is comprised of nitric acid and hydrochloric acid.

12. The method of claim 11 wherein the nitric acid and hydrochloric acid is in the molar ratio of 1:3.

13. The method of claim 6 wherein the ratio of acid solution to metal oxide mixture is 4 ml of acid to each gram of metal oxide mixture.

14. The method of claim 6 wherein the addition of the acid causes the pH of the bath to be less than zero.

15. The method of claim 6 wherein the addition of the base causes the pH of the bath to be in the range of 3 - 3.5.

16. The method of claim 6 wherein the base is comprised of water or sodium hydroxide or both water and sodium hydroxide.

17. The method of claim 6 wherein the heating of the product is done at least at 400° C.
